(19) United States
(12) Patent Application Publication
(10) Pub. No.: US 2015/0096446 A1
(43) Pub. Date: Apr. 9, 2015

(54) DUST-COLLECTING DEVICE OF A SECONDARY DUST-COLLECTING MACHINE

(71) Applicant: SAN FORD MACHINERY CO., LTD., Taichung (TW)

(72) Inventor: Yun-Tai CHENG, Taichung (TW)

(73) Assignee: SAN FORD MACHINERY CO., LTD., Taichung (TW)

(21) Appl. No.: 14/046,124

(22) Filed: Oct. 4, 2013

(51) Int. Cl. B01D 45/16; B01D 46/42; B01D 50/00

(52) U.S. Cl. CPC B01D 45/16; B01D 50/002; B01D 46/4254
USPC 96/380; 55/345; 55/327; 96/416

(57) ABSTRACT

A dust-collecting device of a secondary dust-collecting machine includes a wind guide barrel having a wind intake and a bottom disposed with a dust-collecting barrel. The wind guide barrel further has its topside mounted with a wind duct installed thereon with a blowing fan and connected with a dust-collecting box, which has a plurality of centrifugal type dust collectors set therein. Thus, outside dust accompanying air can be sucked into the wind guide barrel through the wind intake by the suction of the blowing fan to have the dust with comparatively large diameter first collected by the dust-collecting barrel. Then, the remaining dust with lighter mass will be collected for a second time by the centrifugal type dust collectors and filtrated by the filter screen for completely filtrating and removing the dust from the operation environment.

### BACKGROUND OF THE INVENTION

1. Field of the Invention

This invention relates to a dust-collecting device of a secondary dust-collecting machine.

2. Description of the Prior Art

Generally, a wood or metal processing factory will produce a large quantity of dust in processing courses to pollute the environment and unfortunately, many wood or metal processing factories nowadays are limited by their factory buildings and can hardly attain excellent effects of ventilation; therefore, dust produced in a processing course will pervade in the operation environment to endanger the operators' health if the operators work for a long period of time in such a dusty environment and inhale excessive amount of dust. In this case, a dust-collecting machine must be installed to filter and remove the dust in the operation environment for effectively solve the problems caused by dust.

A conventional dust-collecting machine includes a wind guide barrel having its circumferential wall bored with a wind intake and its bottom provided with a dust-collecting port having a dust-collecting barrel fitted thereon. The wind guide barrel further has its topside formed with a wind outlet, with a blowing fan provided at the location of the wind outlet and a filter barrel disposed on the wind outlet. Thus, outside dust accompanying air will be sucked into the wind guide barrel through the wind intake by suction produced by the blowing fan and simultaneously, the dust will sink and flow downward along the circumferential wall of the wind guide barrel in a spiral mode to have comparatively large particles contained in the dust first filtrated and removed by the dust-collecting barrel and then the remaining dust accompanying the air will flow toward the wind outlet to have the rest of the dust further filtrated and removed by the filter barrel and then exhausted back to the outside anew, attaining an effect of filtrating the dust and air in an operation environment.

However, after long-term use and observation, the inventor of this invention finds that although the conventional dust-collecting machine can function to filter slightly larger particles of dust in an operation environment, there is still a certain probability that a small quantity of dust with lighter mass may be mixed therein and unable to be removed. Therefore, the inventor of this invention endeavors to do everything better and thinks that the conventional dust-collecting machine is necessary to be ameliorated and hence devised this invention.

### SUMMARY OF THE INVENTION

This invention is devised to offer a dust-collecting device of a secondary dust-collecting machine for attaining the objective of completely filtrating and removing all the dust in an operation environment by carrying out secondary dust collection for further filtering and removing the dust with lighter mass.

The dust-collecting device of a secondary dust-collecting machine in the present invention includes a wind guide barrel having its circumferential wall bored with a wind intake. The wind guide barrel has a bottom provided with a dust-collecting port and its topside disposed with a wind guide port. A dust-collecting barrel is mounted on the dust-collecting port, communicating with the wind guide barrel. A wind duct is connected with the wind guide port, bored with a dust-collecting port and installed thereon with a blowing fan at a location close by the wind guide port. A dust-collecting box is assembled on the dust-collecting port of the wind duct and communicates with the wind duct. A fixed plate is horizontally set in the interior of the dust-collecting box, positioned at the upper edge of the dust-collecting port and bored with a plurality of insert holes. A plurality of centrifugal type dust collectors are respectively fixed with the lower edges of the insert holes and respectively formed with an inner tube, which has one end secured with the insert hole and another end formed into a free end. An outer tube is fitted around the inner tube, having one end hermetically connected with the circumferential side of the inner tube and another end gradually contracted to form a convergent portion having an opening formed at the end. The outer tube further has a circumferential side provided with a wind inlet.

The dust-collecting device of a secondary dust-collecting machine of this invention functions to have outside dust accompanying air sucked into the wind guide barrel through the wind intake by the suction produced by the blowing fan. Simultaneously, the dust together with the air will spirally flow downward along the circumferential wall of the wind guide barrel to have comparatively large particles contained in the dust first filtrated and removed by the dust-collecting barrel. Then, the remaining dust together with the air will flow toward the dust-collecting box through the wind duct to have the rest of the dust with lighter mass further filtrated and removed for a second time by the centrifugal type dust collectors and after filtrated, the air will exhaust back to the outside, thus able to completely filter and remove the dust from an operation environment.

### BRIEF DESCRIPTION OF DRAWINGS

This invention will be better understood by referring to the accompanying drawings, wherein:

FIG. 1 is a schematic view of the outward appearance of a dust-collecting device of a secondary dust-collecting machine in the present invention;

FIG. 2 is a cross-sectional view of the dust-collecting device in the present invention;

FIG. 3 is a perspective view of a centrifugal type dust collector of the dust-collecting device in the present invention;

FIG. 4 is a schematic view of the dust-collecting device in a using condition in the present invention;

FIG. 5 is a schematic view of the centrifugal type dust collector in a using condition in the present invention; and

FIG. 6 is an upper view of a noise reduction box of the dust-collecting device in the present invention;

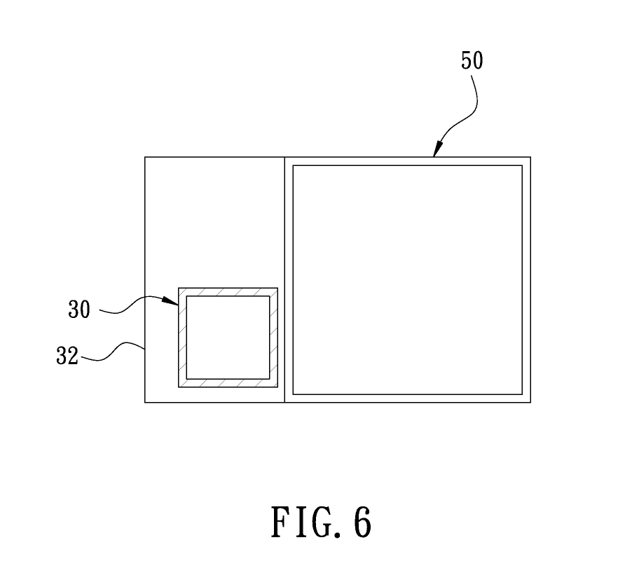

### DETAILED DESCRIPTION OF THE PREFERRED EMBODIMENT

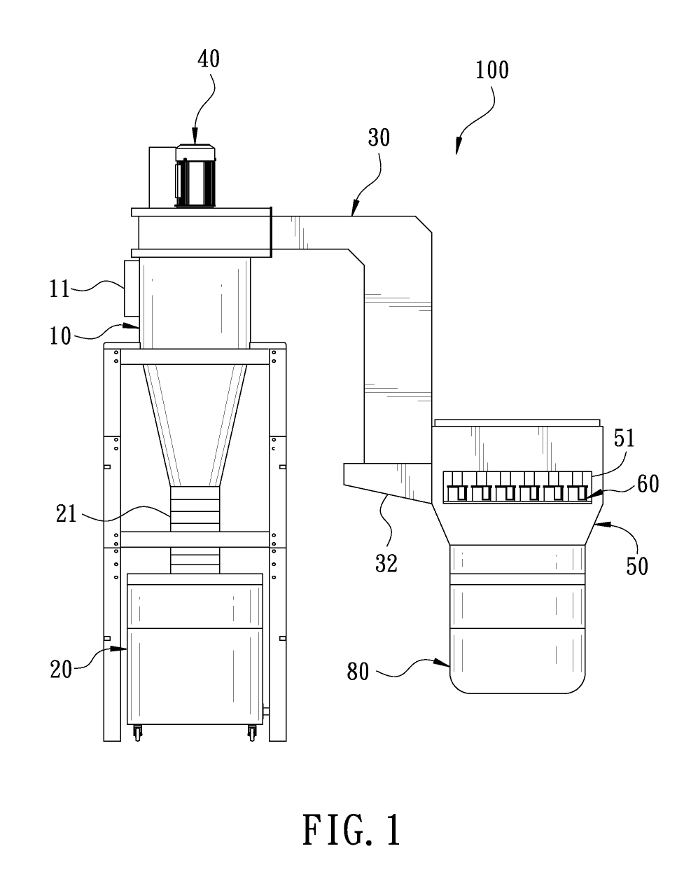

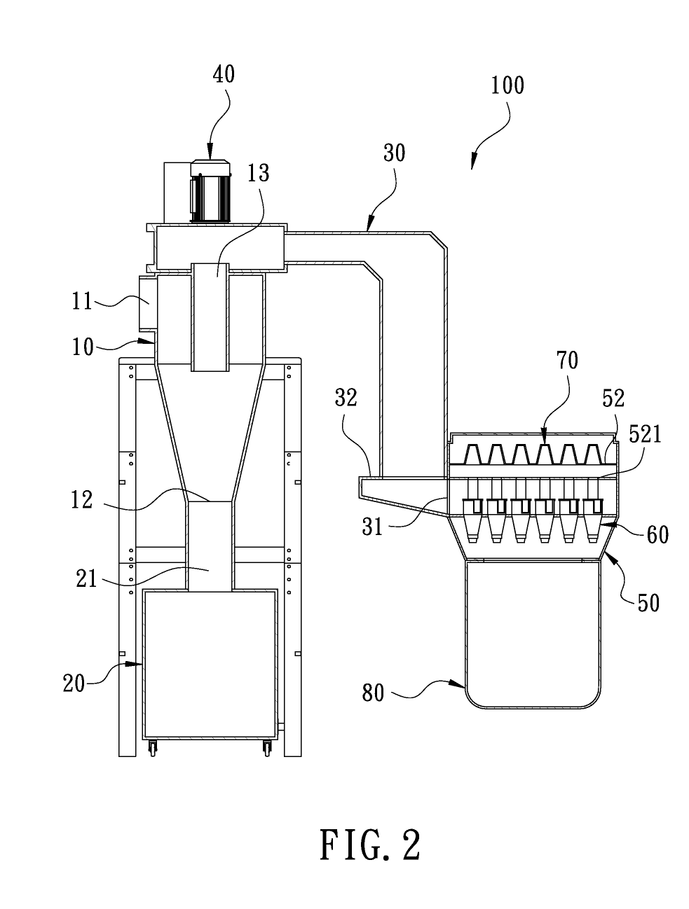

A preferred embodiment of a dust-collecting device 100 of a secondary dust-collecting machine in the present invention, as shown in FIGS. 1 and 2, includes a wind guide barrel 10, a dust-collecting barrel 20, a wind duct 30, a blowing fan 40, a dust-collecting box 50, a plurality of centrifugal type dust collectors 60, a filter screen 70 and a dust-collecting bag 80 as main components combined together.

The wind guide barrel 10 has a circumferential wall bored with a wind intake 11 able to be connected with a pipe. The wind guide barrel 10 is gradually contracted toward the bottom, having a lower side formed with a dust-collecting opening 12 and an upper side disposed with a wind guide port 13.

The dust-collecting barrel 20 is assembled on the dust-collecting opening 12 of the wind guide barrel 10 and provided with a flexible pipe 12 for communicating the dust-collecting barrel 20 with the wind guide barrel 10.

The wind duct 30 connected with the wind guide part 13 of the wind guide barrel 10 is formed with a dust-collecting port 31 and provided with a noise reducing box 32 fixed at the location of the dust-collecting port 31. The cross-sectional area of the noise reducing box 32 is larger than that of the wind duct 30 and the noise reducing box 32 is gradually enlarged toward the dust-collecting port 31.

The blowing fan 40 is assembled on the wind dust 30 and located close by the wind guide port 13.

The dust-collecting box 50 is positioned on the dust-collecting port 31 of the wind duct 30, communicating with the wind duct 30 and provided with a transparent window 51. A fixed plate 52 is horizontally disposed in the interior of the dust-collecting box 50, set at the upper edge of the dust-collecting port 31 and bored with a plurality of insert holes 521.

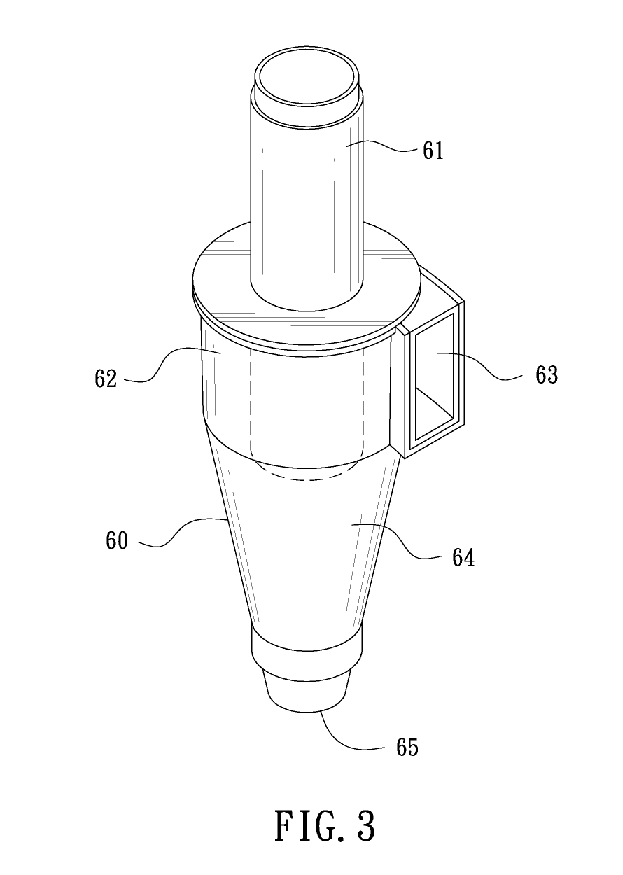

The centrifugal type dust collectors 60 are respectively provided at the lower edge of the insert holes 521 of the fixed plate 52. Referring to FIG. 3, each centrifugal type dust collector 60 is formed with an inner tube 61 having one end secured with the insert hole 521 and another end formed into a free end. The inner tube 61 has its outer side fitted with an outer tube 62, which has one end hermetically connected with the circumferential side of the inner tube 61 and another end gradually contracted to form a convergent portion 64 having an opening 65 bored at the end. The outer tube 62 further has a circumferential side formed with a wind intake 63.

The filter screen 70 is mounted on the fixed plate 52.

The dust-collecting bag 80 is positioned under the dust-collecting box 50 and communicates with the dust-collecting box 50.

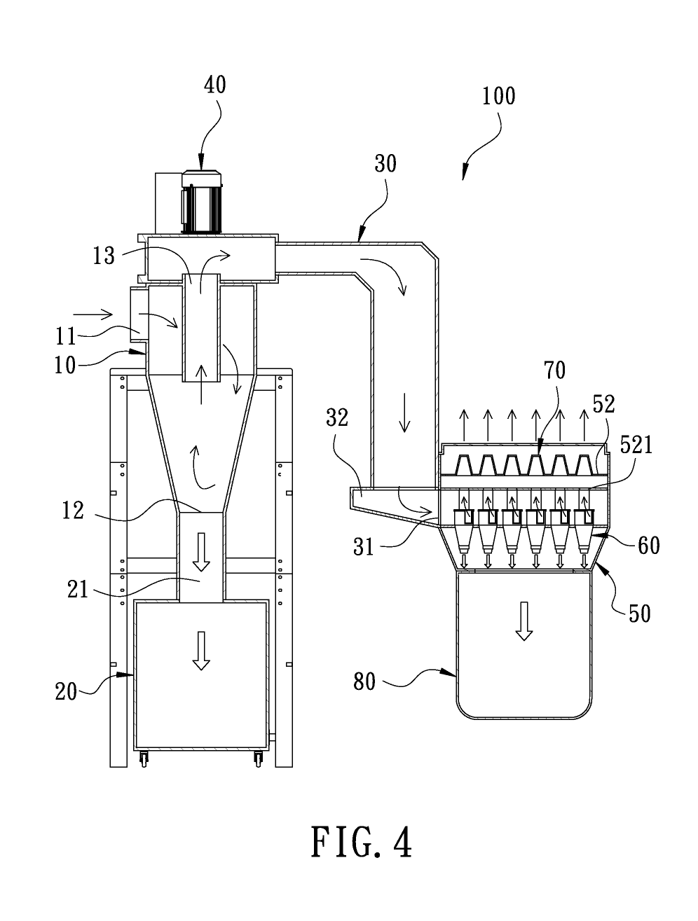

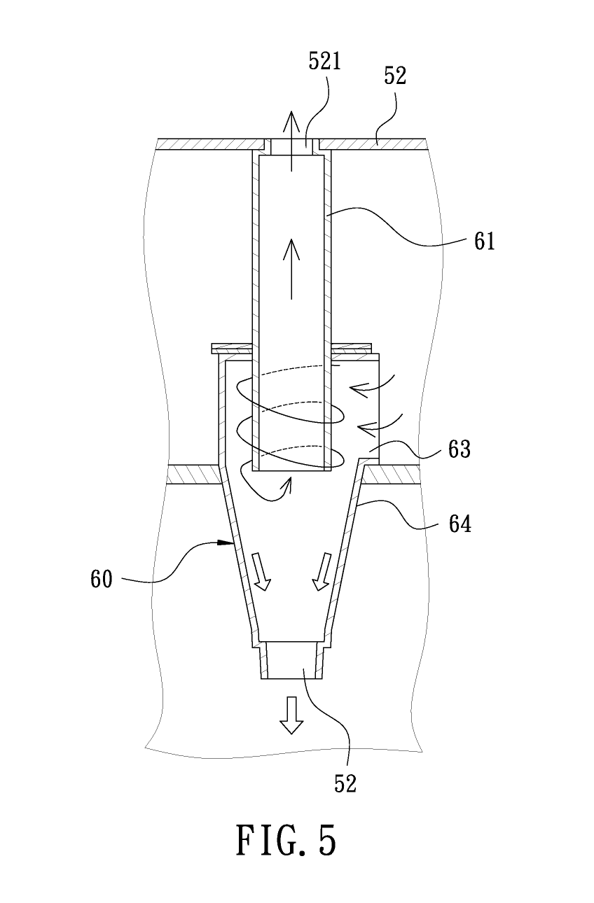

In using referring to FIGS. 4 and 5, after the dust-collecting device 100 of the secondary dust-collecting machine is started, the blowing fan 40 will produce suction to suck outside dust together with air into the wind guide barrel 10 through the wind intake 11 of the wind guide barrel 10 and simultaneously, the dust and air will spirally flow downward along the circumferential side of the wind guide barrel 10, and comparatively large particles in the dust will take the advantage of opportunity to drop into the dust-collecting barrel 20 to be removed by the dust-collecting barrel 20, and the remaining dust with comparatively small diameter particles accompanying the air will get into wind duct 30 through the wind guide port 13 and then flow toward the dust-collecting box 50 via the wind duct 30. After getting into the dust-collecting box 50, the dust accompanying the air will flow into the centrifugal type dust collectors 60 through the wind inlets 63 of the outer tube 62. At this time, the dust and air will spirally flow downward along the inner circumferential side of the outer tube 62 to form an air current at the location of the convergent portion 64 and meanwhile, the centrifugal force produced by the air current will cast out the dust to let the dust drop into the dust-collecting bag 80 under the dust-collecting box 50 through the opening 65. Thus, the remaining dust with lighter mass can be filtered and eliminated, while the air will be guided by the inner tube 61 to pass through the insert holes 521 of the fixed plate 52 to have the remaining dust further filtered by the filter screen 70 and then, the air will be exhausted back to the outside again. By so designing, the dust-collecting device 100 of a secondary dust-collecting machine of this invention can provide multiple filtering effects to attain an objective of completely filtrating and removing the dust from an operation environment.

One of the special features of this invention is that the noise reducing box 32 larger than the wind duct 30 in the cross-sectional area is provided at the location of the dust-collecting port 31 of the wind duct 30, able to form a buffer space, and the noise reducing box 32 is gradually enlarged toward the dust-collecting port 31 to form a sloping guide face. Thus, when air gets into the dust-collecting box 50 through the wind duct 30, there will form a buffer at the location of the noise reducing box 32, and the air can conveniently be guided into the dust-collecting box 50 by means of the sloping guide face of the noise reducing box 32, able to lower the pressure and the flow speed of gas when the air gets into the dust-collecting box 50 and hence attain an effect of noise reduction.

While the preferred embodiment of the invention has been described above, it will be recognized and understood that various modifications may be made therein and the appended claims are intended to cover all such modifications that may fall within the spirit and scope of the invention.

What is claimed is:

1. A dust-collecting device of a secondary dust-collecting machine comprising:
a wind guide barrel having a circumferential wall bored with a wind intake, said wind guide barrel having a lower side disposed with a dust-collecting port, said wind guide barrel further having an upper side provided with a wind guide port;
a dust-collecting barrel assembled on said dust-collecting port of said wind guide barrel, said dust-collecting barrel communicating with said wind guide barrel;
a wind duct connected with said wind guide port of said wind guide barrel, said wind duct formed with a dust-collecting port;
a blowing fan installed on said wind duct and positioned close by said wind guide port;
a dust-collecting box mounted on said dust-collecting port of said wind duct, said dust-collecting box communicating with said wind duct, a fixed plate set in said dust-collecting box and positioned at an upper edge of said dust-collecting port, said fixed plate bored with a plurality of insert holes;
a plurality of centrifugal type dust collectors arranged in said dust-collecting box, each said centrifugal dust collector formed with an inner tube, said inner tube having one end secured with said insert hole of said fixed plate, said inner tube having another end formed into a free end, said inner tube fitted thereon with an outer tube, said outer tube having one end hermetically connected with an circumferential side of said inner tube, said outer tube having a circumferential side provided with a wind intake, said outer tube having another end gradually contracted and formed into a convergent portion, said convergent portion bored with an opening at the end; and
a dust-collecting bag fastened under said dust-collecting box, said dust-collecting bag communicating with said dust-collecting box.

2. The dust-collecting device of a secondary dust-collecting machine as claimed in claim 1, wherein a noise reducing box is provided at the location of said dust-collecting port of said wind duct, and the cross-sectional area of said noise reducing box is larger than that of said wind duct, said noise reducing box gradually enlarged toward said dust-collecting port.

3. The dust-collecting device of a secondary dust-collecting machine as claimed in claim 1, wherein said fixed plate is assembled thereon with at least one filter screen.

4. The dust-collecting device of a secondary dust-collecting machine as claimed in claim 1, wherein said dust-collecting box is formed with at least one transparent window.
